(19) United States
(12) Patent Application Publication
(10) Pub. No.: US 2006/0141440 A1
(43) Pub. Date: Jun. 29, 2006

(54) Instructional method, resource manual and guide for student-developed textbooks

(76) Inventor: Myles Johnson, Minneapolis, MN (US)

Correspondence Address: ALTERA LAW GROUP, LLC, 6500 CITY WEST PARKWAY, SUITE 100, MINNEAPOLIS, MN, 55344-7704, US

(21) Appl. No.: 11/027,632

(22) Filed: Dec. 28, 2004

(51) Int. Cl. G09B 3/00

(52) U.S. Cl. 434/350

(57) ABSTRACT

An instructional method, resource manual and guide is provided, whereby instructors enable students to create and/or develop course texts that contain the precise information the instructor desires and texts that are uniquely and individually customized to the individual student's needs with assistance and supervision from the instructor. The preferred embodiment utilizes the Internet as a primary resource, though alternative resources may be used. The purpose of the inventive method is to provide a way to increase the learning of students by their production of a text that contains the information the instructor desires while allowing students to create their own unique, customized text that is geared to meet the individual student's needs. The inventive method thus addresses a vexing problem. Specifically, the instructor enters a course with certain academic topics and educational goals in mind, and strives to bring each student to an educational level that at least meets these goals. Individual students, however, have varied background knowledge of a course, as well as varying knowledge of particular topics contained within the course. Students also have varying degrees of general academic ability and skill levels, e.g., reading ability. The invention enables each student to begin a topic at the proper academic level. Thus, the instructor can assist students through the various learning stages for individual topics, ultimately ensuring to the extent possible that each educational goal is met or exceeded by all students, regardless of background knowledge, academic ability or skill level.

### FIELD OF THE INVENTION

This invention relates generally to instructional methods and an instructional resource manual and guide for enabling students to develop their own unique and customized textbook for a particular course.

### BACKGROUND OF THE PRESENT INVENTION

There is often general dissatisfaction among faculty and students with traditional scholastic textbooks. For example, a text may not contain all of the topics the faculty member wishes to include in a course, while including many topics they feel are extraneous. Additionally, the extensiveness or depth of coverage may not be optimal, or the textual organization may not match the course curriculum. Finally, students have different levels of background knowledge of individual topics, as well as varying skill levels and learning styles. Traditional textbooks do not allow the flexibility and fluidity needed to address the individualized needs of students on a topic-by-topic basis while ensuring that the basic information has been provided to each student.

In an attempt to rectify these shortcomings, many educational institutions and/or instructors now require that students supplement current textbooks with material derived from sources such as the world-wide web as well as compiled readings and the like. Though this may solve some of the shortcomings of the traditional textbook-based approach, many of the problems described above still remain.

In addition, several patent publications in the general area require mention and distinguishing from the present invention. U.S. Pat. App. No. 20020119435 to Himmel, et al., describes a compilation of electronic content relating to use of an on-line educational system. Himmel provides for an on-line electronic course syllabus that identifies assignments and educational materials. Students access the electronic syllabus, access the assignments and educational materials provided thereon. The system compiles and records electronic content designed to create an on-line library documenting the student's experience over several educational courses over time as the student progresses toward a degree or other academic goal.

This method provides for on-line provision, and access of, a course syllabus. In addition, the method creates libraries comprised of on-line searches performed, the query used and corresponding search results. The method does not, however, disclose or suggest a method whereby students conduct individualized research sessions on a particular topic, determine which search results are necessary and relevant and thus retained, and which are to be discarded, organization of the retained search results in an individualized manner or structure with methods of confirmation that the search results are indeed accurate and on point, culminating in an individualized student textbook.

U.S. Pat. App. No. 20030008269 to Helmick, et al., describes an on-line educational system for document sharing. Helmick thus provides for a system whereby the instructor compiles an on-line electronic syllabus that is accessible by students. The disclosure allows for on-line sharing of certain documents between course participants and/or the instructor. The publication does not, however, disclose or suggest a method whereby students conduct individualized research sessions on a particular topic, determine which search results are necessary and relevant and thus retained, and which are to be discarded, organization of the retained search results in an individualized manner or structure with methods of confirmation that the search results are indeed accurate and on point, culminating in an individualized student textbook.

U.S. Pat. App. No. 20020102524, to Rizzi et al., describes a system and method for developing instructional materials using a content database. Rizzi discloses an editing system for developers of instructional materials whereby such materials may be designed and edited from a database of content. The publication does not, however, disclose or suggest a method whereby students conduct individualized research sessions on a particular topic, determine which search results are necessary and relevant and thus retained, and which are to be discarded, organization of the retained search results in an individualized manner or structure with methods of confirmation that the search results are indeed accurate and on point, culminating in an individualized student textbook.

Thus, an instructional method and instructional resource manual and guide is needed that overcomes each of the problems and limitations outlined above.

The present invention accomplishes these goals.

### SUMMARY OF THE INVENTION

An instructional method, resource manual and guide is provided; whereby instructors enable students to create and/or develop course texts that contains the precise information the instructor desires and texts that are also unique and individually customized to the individual student's needs with assistance and supervision from the instructor. The preferred embodiment utilizes the Internet as a primary resource, though alternative resources may be used. The purpose of the inventive method is to provide a way to increase the learning of students by their production of a text that contains the information the instructor desires while allowing students to create their own unique, customized text that is geared to meet the individual student's needs. The inventive method thus addresses a vexing problem for many instructors. Specifically, the instructor enters a course with certain academic topics and educational goals in mind, and strives to bring each student to an educational level that meets these goals. Individual students, however, have varied background knowledge of particular topics contained within the course. Students also have varying degrees of general academic ability and skill levels, e.g., reading ability. The invention, among other things, enables each student to begin, on a topic-specific basis, at the proper academic level and progress ultimately to the instructor's educational goal. As used herein, the phrase “proper academic level” is meant, among other things, the basic entry point for specific topics for an individual student. This entry point is comprised and based upon and number of criteria, e.g., basic reading level, background knowledge of the topic, preferred learning media, etc. Thus students begin studying a particular topic by selecting materials that match their individual knowledge and ability level. In this way, the instructor can assist students in learning individual topics, ultimately ensuring to the extent possible that each educational goal is met or exceeded by all students, regardless of background knowledge, academic ability or skill level. The invention also creates an intrinsically motivating educational experience.

Under certain embodiments of the invention, the instructor provides a syllabus containing educational topics and may, in some embodiments, provide certain key words or terms, concepts, theories or even designated Internet website addresses to focus the students in their search for relevant text materials. This method provides the students with the flexibility to explore the material in a creative and self-driven and focused manner while ensuring that the concepts deemed critical to the text are located. In addition, the method provides many pedagogical advantages. Students are, e.g., encouraged to locate relevant material and make cognitive decisions about the value of the content. In this manner, highly valuable characteristics such as enhanced critical thinking abilities, improved cognitive reasoning skills, improved research skills, individual student ownership of the created text and the material compiled therein, pride in the accomplishment and more direct involvement in one's education are fostered. Moreover, the student is exposed to the most recent advancements in any field of study. This method may be practiced using a resource manual and guide for student developed texts and may be modifiable to suit virtually any academic discipline that may be developed by an expert in the field.

Thus, the invention represents a revolutionary departure from the long-standing educational tradition where the instructor or academic department selects a single text for all students.

An object of the invention is to provide an instructional method that results in the generation of individualized, unique student texts, preferably using the Internet as a resource, but also includes use of other traditional research sources.

Another object of the invention is to provide an instructional method that requires the student to read and make decisions about the material to include in the newly created text.

Another object of the invention is to provide an instructional method that improves the student's research, critical thinking and cognitive reasoning skills.

Yet another object of the invention is to provide an instructional method that provides the student with the most current and topical information available.

Another object of the invention is to provide an instructional method that provides students with a sense of accomplishment and pride of ownership in their newly created text as well as very direct involvement in his or her own educational process.

Yet another object of the invention is to provide an instructional method that allows the student to organize the materials within the text to that it has individualized meaning.

Another object of the invention is to provide an instructional method that allows the student to select from a number of different types of sources varying in difficulty, thoroughness and method of presentation in order to better match his or her learning style and background knowledge of the topics.

Still another object of the invention is to provide an instructional method that does not require a significant upfront economic investment.

Another object of the invention is to provide an instructional method that provides texts yet does not require significant periodic and cyclical economic investments.

Yet another object of the invention is to provide an instructional method that capitalizes on an ever-expanding growth in technology in education.

Still another object of the invention is to provide an instructional method that enables virtually instantaneous reinforcement of the student's search process.

Another object of the invention is to provide an instructional method that intrinsically motivates students to obtain the correct information.

Yet another object of the invention is to provide an instructional method that motivates and encourages sharing of topical sources and interaction between students, as well as between students and the instructor.

Another object of the invention is to provide an instructional method and resource manual and guide that utilizes the students' knowledge and skills in searching the Internet.

Another object of the invention is to provide a resource manual and guide for a student developed text for a plurality of academic disciplines.

The foregoing objects of the invention will become apparent to those skilled in the art when the following detailed description of the invention is read in conjunction with the accompanying drawings and claims. Throughout the drawings, like numerals refer to similar or identical parts.

### BRIEF DESCRIPTION OF THE DRAWINGS

FIG. 1 is a flowchart of the inventive process.

### DETAILED DESCRIPTION OF THE INVENTION

Herein is provided an instructional method and, in certain embodiments, an accompanying resource guide and manual, whereby instructors enable students to create and/or develop course texts that contain the precise information the instructor desires and that are also customized to the specific course, and topic, and to the individual student, all with assistance and supervision from the instructor.

A purpose of the inventive method is to provide a way to increase the learning of students by their production of a text that contains the exact information the instructor desires while allowing students to create their own unique, customized text that is geared to meet the individual student's needs. The inventive method thus addresses what is a historically difficult issue for many instructors at all educational levels. Specifically, the instructor begins teaching a course with certain educational topics and goals in mind, and strives to bring each student to an educational level that meets these goals. This is difficult, however, because students possess a great variety of background knowledge of a course, as well as varying knowledge of particular topics contained within the course. Students also have varying degrees of general academic ability, motivational levels and skill levels, e.g., reading ability. The invention, among other things, enables students to begin, on a topic-specific basis, at an individualized and proper academic level and progress ultimately to locate and understand the materials that match their individual abilities and skill levels and that meet the instructor's educational goal(s). Highly motivated students may progress beyond the instructor's goal(s). In this way, the instructor can assist students while they learn individual topics, regardless of background knowledge, academic ability or skill level.

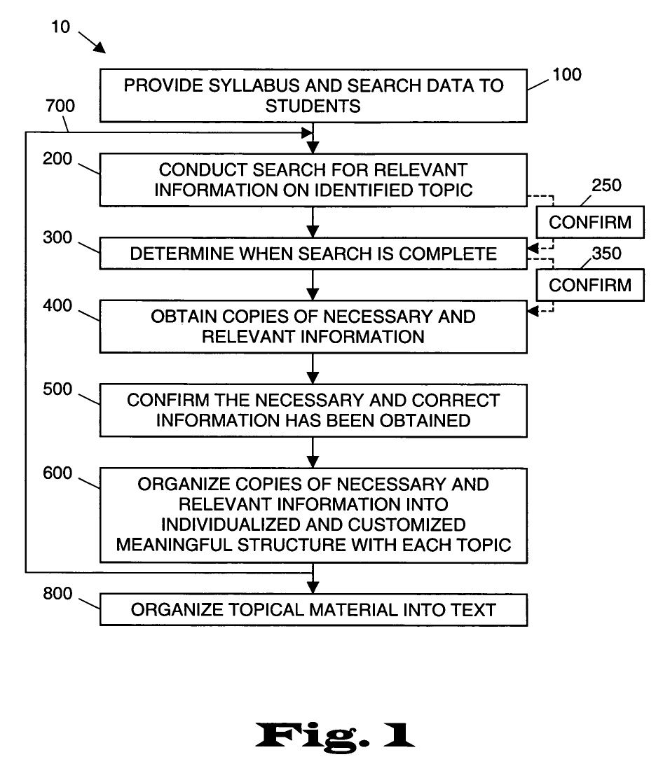

Referring specifically now to FIG. 1, the method 10 comprises a number of process steps. The instructor first provides the students with a course syllabus and search data 100. The syllabus may be provided to students either online, in an electronic format accessible by computers or in hard copy, paper form.

The instructor has a number of options in this step including varying the specificity of the search data provided the students. Generally, in one embodiment of the inventive method, the instructor may provide students with specific selected on-line Internet addresses or library reference citations. This strategy will lead the students directly to the precise information that the instructor desires the students to locate. Such a strategy may be utilized, e.g., in topical areas that are extremely difficult or in areas where there is a tremendous amount of misinformation. Generally then, this particular embodiment will result in locating certain information or data that is presented in a certain desired or preferred manner, e.g., journal articles.

A second strategy for the provision of search-related information, materials or data 100 may be simply providing students with the topic itself, together with associated concepts and terms that assist in focusing on the topic, and assigning students the task of locating relevant information that are appropriate to the individual student's skill and academic level. Students are then free to utilize essentially any research mechanism to discover information related to the assignment, including Internet search engines or other more traditional research methodologies. Traditional research methodologies are well understood by those skilled in the art and include, inter alia, informational searches performed in libraries and using reference books.

In addition to the above, the instructor may organize the sources by academic level or by the background knowledge required to most efficiently begin study of the topic as an alternative to students selecting those sources that are appropriate. Stated slightly differently, the sources may be arranged and organized by difficulty, e.g., easy, medium and difficult source listings may be provided for individual topics. This allows students with various academic needs to begin researching a topic at the most efficient-point on an individualized basis.

The second method step 200, comprises the actual search for necessary and relevant information on the assigned topic and is dependent upon the strategy selected by the instructor to provide source information in the syllabus as described above. Those skilled in the art will readily recognize that any Internet-based search engine as well as the more traditional library and book-based research strategies, or combination thereof, will be within the scope of this embodiment of the inventive method. This embodiment of the inventive method may, however, lead the student to many and varied resources that are related to the assigned topic. Such resources may vary in difficulty, thoroughness, accuracy, and method of presentation, e.g., review outlines, periodical articles, multimedia presentations, excerpts from scholarly works, non-fiction works and fiction works to name a few. Employing the Internet to practice various embodiments of the invention thus capitalizes on the students' access to the ever-expanding technology presence in schools and at home.

Depending upon the research strategy employed by the student, the inventive method allows the student access to the most current data and information available on any given topic. In certain disciplines, for example, the sciences, such access can be key to a quality educational experience because many of the scientific fields advance quickly. Traditional texts are less than optimal in such fields because some of the covered topics may be out of date before the text is published. The inventive method is not subject to this obstacle.

In addition, the student may identify those search materials that are necessary and relevant to the topic previously identified by the instructor in the syllabus. This will require the student to exercise individualized judgment including reference to his or her background knowledge on the assigned topic. Students with less background knowledge of a particular topic may require more carefully organized and more thorough materials, and materials that may begin at a more basic academic level. On the other hand, the students bringing more background knowledge on a particular topic may require significantly less thorough, or more advanced, materials to understand the topic. In addition, students' learning styles differ; some learn more effectively through multimedia materials, while others require textual information and still others a combination thereof. Thus, in various embodiments, the text that is undergoing creation is unique to the student assembling the materials; customized to his or her individual academic needs. Those skilled in the art will readily recognize that the identification of necessary and relevant information may proceed essentially simultaneously with the location of information or, in alternative embodiments, proceed as a distinct step following the locating of topic-relevant information.

Thus, it is apparent that the inventive method necessarily requires the student to evaluate or appraise the quality, i.e., accuracy and precision, of the search results in deciding which results to keep and which to discard. Such an exercise develops students' critical thinking and cognitive reasoning skills.

Once the search 200 is complete, the student's search results may, in certain embodiments, be confirmed for accuracy and sufficiency 250. In alternative embodiments, the confirmation step 250 is not formally performed. Such confirmation may be accomplished in several ways. First, the instructor may discuss the assigned topic with students in class or electronically using an online discussion forum, various embodiments being well-known in the art. Such discussion may provide students with a checkpoint to ensure that the located material is, indeed, both on point and sufficient to accomplish the course's objectives. Second, students may form groups either in class or online to share and discuss their research results. Such group discussions encourage cooperative work among students and the sharing of knowledge. Third, students may at any time during the process contact the instructor to determine if they have the correct information. This method encourages contact and interaction between the student and the instructor. Finally, study questions may be provided via the syllabus or other mechanisms well known in the art to invite interaction, aid and check learning, and/or to confirm that the necessary and relevant information was found and is understood for each topic. It should be readily evident that each method for information correctness confirmation may be combined with one other such method or, alternatively, all methods may be combined.

In addition, it will be recognized that performing the search and identification of necessary and relevant information thereof, 200, as described above necessarily requires the student to exercise judgment in determining when a sufficient amount of material has been acquired on the assigned topic. Thus, determination of when the search is complete 300 is provided as the next step. There are a number of ways this may be accomplished. As described above, the search may be complete when the student accesses the precise research citation and/or Internet address the instructor has directed them to. In alternate embodiments, the completion judgment is not as simple and requires individualized judgment by the student who relies, inter alia, upon the focus of the course, the topic assigned by the instructor 100, and the student's individualized background knowledge of the assigned topic. Where the search is not limited to particular reference locations, the student may recognize that certain topics and references begin to repeat themselves during the search process. This may be, in certain embodiments of the invention, a prompt to the student indicating that the search is complete and thorough and has located all concepts, theories and/or terms provided in the syllabus. In this manner the student is required to make a reasoned judgment that the search is complete or additional work is required. In certain subject areas and in various embodiments of the inventive method, e.g., areas concerning science and mathematics research topics, the student's search may be complete when each element of the problem has been separated, evaluated and understood via the research process. This step increases the students' research, critical thinking and cognitive reasoning skills.

Again a confirmation step may be utilized to ensure that method step 300 has been executed to the satisfaction of the instructor and the course goals 350. As discussed above in relation to method steps 250, such confirmation, if required, may be achieved in various manners.

When the student has identified the search is indeed complete, he or she obtains copies of the same 400. It will readily be apparent that such copies may be obtained and stored either electronically, e.g., on a computer hard drive or disk, or hard copies via a printer or copier. The copies may be used for future reference by the student for studying purposes and, under certain circumstances, the sources may be shared with others.

Once copies have been obtained 400, the student may confirm that the necessary and correct information has been obtained 500. As discussed above, this may be accomplished in several ways. First, the instructor may discuss the assigned topic with students in class or electronically using an online discussion forum, various embodiments being well-known in the art. Such discussion may provide students with a checkpoint to ensure that the material compiled is, indeed, both on point and sufficient to accomplish the course's objectives. Second, students may form groups either in class or online to share and discuss their research results. Such group discussions encourage cooperative work among students and the sharing of knowledge. Third, students may contact the instructor at any time during the process to determine if they have the correct information. This method encourages contact and interaction between the student and the instructor. Finally, study questions may be provided via the syllabus or other mechanism well known in the art to invite interaction, aid and check learning, and/or to confirm that the necessary and relevant information was found and is understood for each topic. It should be readily evident that each method for information correctness confirmation may be combined with one other such method or, alternatively, all methods may be combined.

When the student confirms the correctness of the material compiled for a particular assigned topic, the student may then organize the copies of confirmed necessary and relevant topical information into a meaningful structure that is individualized and customized to the student's needs 600, thus increasing the potential for success in learning.

When a particular topic has been researched and the materials organized into a meaningful structure 600, the process may be repeated for the next assigned topic 700 until ultimately, the course syllabus has been completed.

Finally, each set of topical materials is organized into an individual and unique text 800. The end result, for a classroom of students, is a group of course texts that are uniquely customized to the subject matter and the compiling student's individual learning style, background knowledge and skill level. The course texts also contain the precise information that the instructor desires.

Certain advantages arise as a result of the inventive instructional method. It will be readily recognized that students working under the method will have a growing sense of accomplishment in their newly created text. In addition, students will develop pride in the ownership over the course material and the created text. This advantage is highly valuable in comparison to the tradition teaching methodologies that rely on traditional textbooks as the only resource. Thus, the inventive method may result in students learning more about the course subject matter than students may in traditional course settings. From an administrative and fiscal standpoint, the major expense of traditional texts is not required under the inventive method. Similarly, the additional expense of purchasing updated revisions to keep pace with the evolving nature of the subject is not required. Finally, and perhaps most significantly, instructors are enabled to effectively teach the desired information to a plurality of students with a wide variety of topical background knowledge, academic abilities and skill levels without being bound to a particular text.

The basic method having been described, a resource manual and guide for student created or developed text will now be disclosed. The manual and guide is designed to be a comprehensive resource for instructors and students. Instructors may choose to use the manual and guide to augment existing course materials or may wish to have students create an entire text using the above-described method.

The resource manual and guide may contain a substantially complete set of on-line resources for each of the main topics typically covered in a particular academic course, e.g., cell biology or introductory psychology. It will be appreciated that the resource manual and guide may be applicable to virtually any academic course. The resource manual and guide may be compiled by an expert in the relevant field.

The sources selected may be Internet-based, or may be non-Internet sources, or combination thereof, and may be included with the resource manual and guide may vary in difficulty, thoroughness and method of presentation to accommodate different styles of learning and levels of background knowledge of the relevant topic. In addition, the resource manual and guide may further comprise a selection of multimedia presentations and include study guide questions to aid students' understanding of the topics and to accommodate learning style differentials. The resource manual and guide may be presented in either a paper format, such as, e.g., a bound or stapled booklet or binder. Alternatively, the resource manual and guide may be provided in electronic CD format or may be downloaded electronically or otherwise accessed via the Internet.

It will be appreciated by those skilled in the art that the invention, including inter alia the instructional method and resource manual and guide described herein is broadly applicable to virtually any age range or subject matter. In addition, because the invention allows the student to draw on the Internet alone, non-Intemet sources, or a combination thereof, the invention may be applied to any educational environment. For example, traditional classroom environments, distance learning course environments, “virtual” university environments and even home schooling environments are within the scope of various embodiments of the invention. Moreover, the invention may, in various embodiments, permit and even encourage the development of topical compilations described herein via students working together in groups and/or teams.

The above specification describes certain preferred embodiments of this invention. This specification is in no way intended to limit the scope of the claims. Other modifications, alterations, or substitutions may now suggest themselves to those skilled in the art, all of which are within the spirit and scope of the present invention. It is therefore intended that the present invention be limited only by the scope of the attached claims below:

1. A method for developing an individually customized textbook, comprising:
providing students with a syllabus of course topics and search data;
conducting a student-performed search for necessary and relevant information on a particular course topic in the syllabus;
determining when the search is complete;
obtaining copies of the necessary and relevant materials;
confirming that substantially all of the necessary and correct information required by the instructor has been obtained;
organizing the necessary and relevant materials into a customized and meaningful structure;
repeating the process for each course topic identified in the syllabus; and
compiling a text of necessary and relevant materials that is unique and customized for individual students.

2. The method of claim 1, further comprising the syllabus being provided to students electronically.

3. The method of claim 1, further comprising the syllabus being provided to students in paper form.

4. The method of claim 1, wherein the search data comprises specific research citations or Internet addresses.

5. The method of claim 1, wherein the search data comprises the relevant course topic.

6. The method of claim 1, wherein conducting the student-performed search further comprises using Internet-based search engines.

7. The method of claim 6, further comprising using traditional library and book-based research methods.

8. The method of claim 1, further comprising providing students access to the most current information on course topics.

9. The method of claim 1, further comprising challenging the quality and relevance of search results as it relates to the relevant course topic.

10. The method of claim 1, further comprising basing the identity of necessary and relevant material on the nature of the student's background knowledge of the relevant course topic.

11. The method of claim 10, further comprising basing the identity of necessary and relevant material on the student's individual learning style.

12. The method of claim 1, further comprising the copies being in paper form.

13. The method of claim 1, further comprising the copies being stored electronically on a computer hard drive or computer disk.

14. The method of claim 1, further comprising using the copies for future reference and studying of the relevant course topic.

15. The method of claim 1, further comprising sharing reference sources with others.

16. The method of claim 1, wherein the organizing of necessary and relevant materials is done to accommodate the student's individual learning style.

17. The method of claim 1, wherein the confirming further comprises providing students with a sense of accomplishment in the compiled text.

18. The method of claim 1, further comprising providing students with a sense of ownership in the course material.

19. The method of claim 18, further comprising assisting students in mastering the course topic material.

20. The method of claim 1, further comprising eliminating the expense associated with purchasing and updating traditional hardcover texts.

21. A resource manual and guide for student developed text, comprising a substantially complete set of sources for the main topics covered in a plurality of academic courses, wherein the sources selected vary in difficulty, thorouglmess and method of presentation to accommodate different styles of learning and levels of background knowledge of the relevant topic.

22. The resource manual and guide of claim 21, wherein the sources further comprise a selection of multimedia presentations to aid students' understanding of the topics.

23. The resource manual and guide of claim 21, wherein the manual is provided in paper printed form.

24. The resource manual and guide of claim 21, wherein the manual and guide is provided in CD format.

25. The resource manual and guide of claim 21, wherein the manual and guide is accessible via the Internet.

26. The resource manual and guide of claim 21, further comprising use of the manual and guide to supplement existing and current course materials or to create an entire student-developed text.

27. The resource manual and guide of claim 21, wherein the sources are Internet based.

28. The resource manual and guide of claim 27 wherein the sources further comprise non-Internet based references.

29. The resource manual and guide of claim 21, wherein the sources are organized by difficulty level.
